(19) United States
(12) Patent Application Publication
(10) Pub. No.: US 2011/0278961 A1
(43) Pub. Date: Nov. 17, 2011

(54) LINEAR VIBRATOR

(75) Inventor: Seung Hyeon JEONG, Seoul (KR)

(73) Assignee: SAMSUNG ELECTRO-MECHANICS CO., LTD.

(21) Appl. No.: 13/101,696

(22) Filed: May 5, 2011

(30) Foreign Application Priority Data
May 14, 2010 (KR) 10-2010-0045657

(51) Int. Cl. H02K 33/00

(52) U.S. Cl. 310/25

(57) ABSTRACT

There is provided a linear vibrator including: a housing having an internal space formed therein; a magnetic field unit including a yoke disposed in the internal space and a magnet mounted on a surface of the yoke, and interacting with a coil to which power is applied to thereby generate vibrations in the internal space; a mass body fixed to an outer surface of the yoke; and a claw part being a portion of the yoke, supporting a bottom of the mass body, and extended to a position corresponding to the center of mass of the mass body.

### CROSS-REFERENCE TO RELATED APPLICATIONS

This application claims the priority of Korean Patent Application No. 10-2010-0045657 filed on May 14, 2010, in the Korean Intellectual Property Office, the disclosure of which is incorporated herein by reference.

### BACKGROUND OF THE INVENTION

1. Field of the Invention

The present invention relates to a linear vibrator, and more particularly, to a linear vibrator capable of alleviating external impacts applied to a vibrator and a stator.

2. Description of the Related Art

A linear vibrator, which is a component converting electrical energy into mechanical vibrations using the principle of generating electromagnetic force, is mounted in an electronic apparatus such as a mobile communications terminal, a portable game machine, or the like, to be used to silently notify a user of call reception by transferring vibrations thereto.

In accordance with the recent trend for compactness and slimness in mobile communications terminals, a compact, multi-functional linear vibrator has also been mounted therein.

A stator and a vibrator, vibrated due to electromagnetic interaction therebetween, are disposed within an internal space of the linear vibrator, according to the related art.

Since internal components forming the vibrator and the stator are disposed in the internal space at a high level of density, interference is caused between the internal components even in the case of small external impacts.

Interference between internal components may cause problems such as the generation of noise, damage, or the like.

Accordingly, there is a demand for research into a linear vibrator in which damage to internal components thereof due to external impacts may be alleviated, in spite of the internal components being disposed at a high level of density.

### SUMMARY OF THE INVENTION

An aspect of the present invention provides a linear vibrator capable of avoiding interference between an outer diameter of a coil and an edge of a yoke due to external impacts and the weight of a mass body.

According to an aspect of the present invention, there is provided a linear vibrator, including: a housing having an internal space formed therein; a magnetic field unit including a yoke disposed in the internal space and a magnet mounted on one surface of the yoke, and interacting with a coil to which power is applied to be vibrated in the internal space; a mass body fixed to an outer surface of the yoke; and a claw part being a portion of the yoke, supporting a bottom of the mass body, and extended to the center of mass of the mass body.

The claw part may be formed to be extended to an outer portion of the center of mass of the mass body.

One of the claw part and the mass body may be formed with a fixing protrusion and the other may be formed with a fixing protrusion receiving part, and the fixing protrusion may be fixed to the fixing protrusion receiving part.

The bottom of the mass body may be formed with an insertion part having the claw part inserted thereinto, and an outer surface of an end of the claw part may be coupled to an inner circumferential surface of the insertion part.

The claw part may has a multi-stage structure and may support the bottom of the mass body in a multi-stage manner.

One of a stepped bottom of the mass body and the claw part surface-contacting the stepped bottom of the mass body may be formed with a fixing protrusion and the other may be formed with a fixing protrusion receiving part, and the fixing protrusion may be fixed to the fixing protrusion receiving part.

The housing may include a cylindrical upper case of which a lower portion is open and a bracket closing the lower portion of the upper case and having the coil mounted thereon.

The housing may include a damper formed on one surface thereof, the damper preventing the magnetic field unit from contacting the housing due to vibration.

The magnetic field unit may be connected to the housing by an elastic member, the elastic member may include an yoke fixing part fixed to the yoke, the yoke may have a flat part having one surface bonded to the yoke fixing part and the other surface fixed to the magnet, and an area of a bonding surface formed by the bonding between the yoke fixing part and the flat part may be smaller than that of the yoke fixing part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view schematically showing a linear vibrator according to an exemplary embodiment of the present invention;

FIG. 2 is a cross-sectional view schematically showing the linear vibrator of FIG. 1;

FIG. 3 is a perspective view schematically showing an elastic member according to an exemplary embodiment of the present invention;

FIG. 4 is a cross-sectional view schematically showing interference between a stator and a vibrator when external impacts are applied to the linear vibrator of FIG. 2;

FIG. 5 is a partially enlarged cross-sectional view showing a modified example of part A of FIG. 2; and

FIG. 6 is a partial cross-sectional view schematically showing a yoke supporting a mass body according to another exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, throughout the drawings, the same or like reference numerals will be used to designate the same or like components having the same functions within the scope of the similar idea.

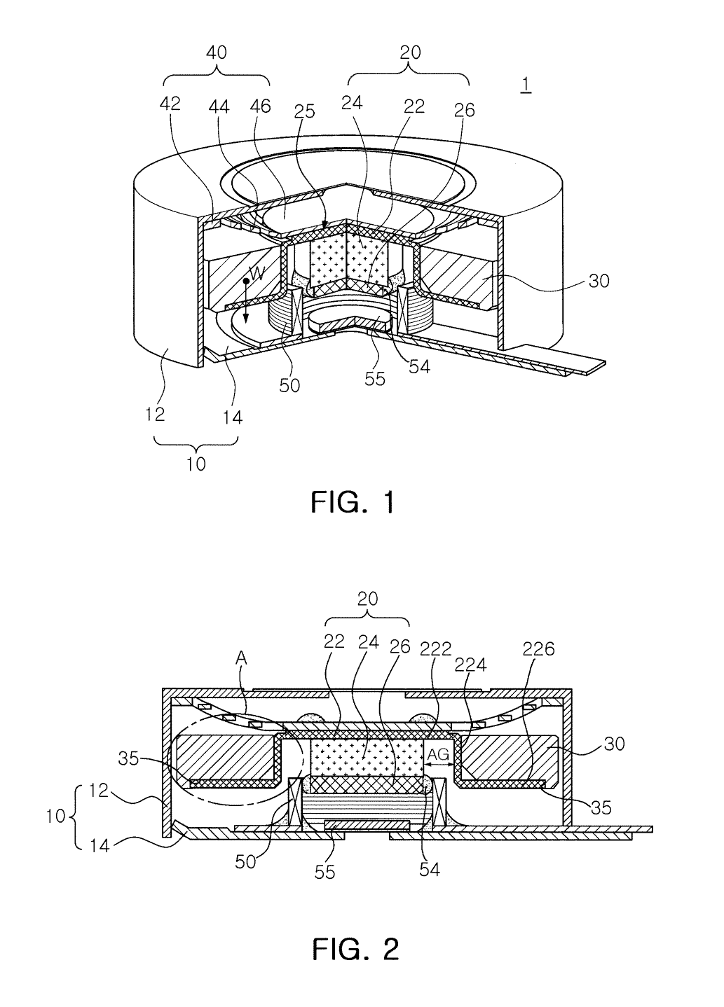

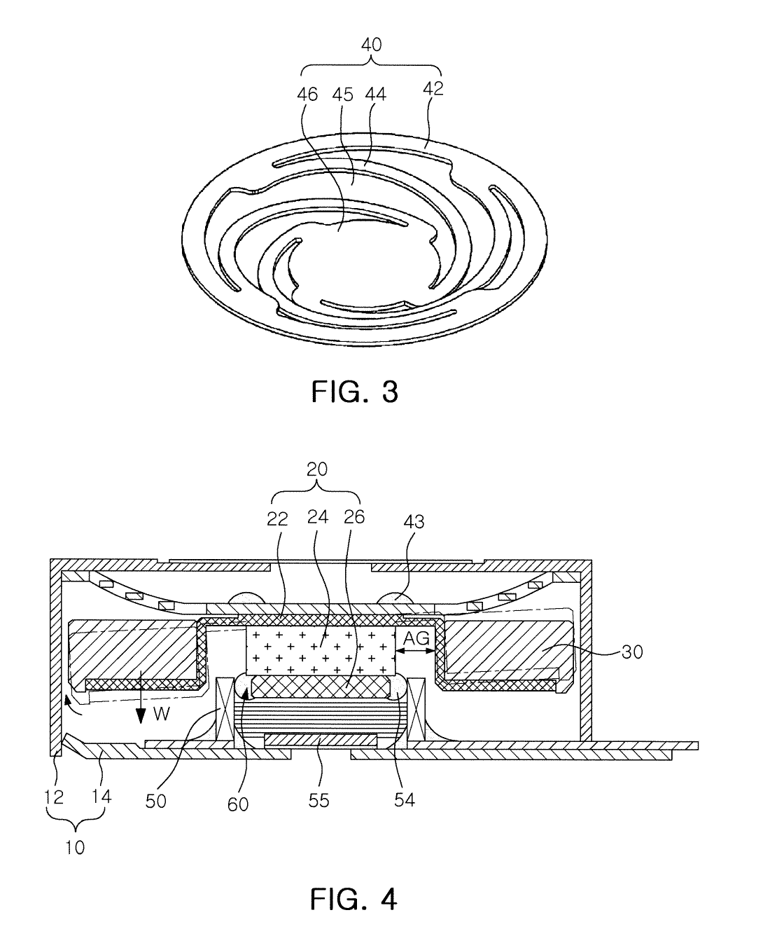

FIG. 1 is a partially cut-away perspective view schematically showing a linear vibrator according to an exemplary embodiment of the present invention; FIG. 2 is a cross-sectional view schematically showing the linear vibrator of FIG. 1; FIG. 3 is a perspective view schematically showing an elastic member according to an exemplary embodiment of the present invention; and FIG. 4 is a cross-sectional view schematically showing interference between a stator and a vibrator when external impacts are applied to the linear vibrator of FIG. 2.

Referring to FIGS. 1 through 4, a linear vibrator 1 according to an exemplary embodiment of the present invention may include a housing 10, a magnetic field unit 20, a mass body 30, and a claw part 226.

The housing 10 may have an internal space formed therein, wherein the internal space has internal components forming a vibrator disposed therein. The housing 10 may be implemented by various methods, and particularly, should be provided such that the internal components may be easily disposed therein.

The housing 10 according to an exemplary embodiment of the present invention may include a cylindrical upper case 12 of which a lower portion is open and a bracket 14 closing the lower portion of the upper case 12 and having a coil mounted thereon.

The magnetic field unit 20 may generate a magnetic field having a predetermined strength, and may include a yoke 22 and a magnet 24 that are disposed in the internal space of the housing 10. In addition, the magnet 24 may include a yoke plate 26 formed on a surface opposite to a contact surface between the magnet 24 and the yoke 22.

The yoke 22 has a cylindrical shape in which an upper portion thereof is closed and a lower portion thereof is opened, and more specifically, may include a flat part 222 having the magnet 24 mounted thereon, a mass body fixing part 224 being bent from the flat part 222 in amounting direction of the magnet 24 to fix a mass body 30, and the claw part 226 being bent from the mass body fixing part 224 to support a bottom of the mass body 30.

The claw part 226, which is a portion of the yoke 22, may be bent from the mass body fixing part 224 to support the bottom of the mass body 30 and may be extended to a position corresponding to the center of mass (W) of the mass body 30.

When the claw part 226 is extended to a position corresponding to the center of mass of the mass body 30, the width of vibrations due to external impacts maybe significantly reduced. When the claw part 226 is extended outwardly of a position corresponding to the center of mass of the mass body 30, the width of vibrations is further increased.

The magnet 24 may be fixedly bonded to one surface of the yoke 22 using an adhesive.

Meanwhile, a diameter of an inner circumferential surface of the yoke 22 is larger than that of an outer circumferential surface of the magnet 24, such that an air gap (AG) having a predetermined size may be formed between the inner circumferential surface of the yoke 22 and the outer circumferential surface of the magnet 24.

The coil 50, allowing current to flow in a magnetic field formed by the magnetic field unit 20 and vibrate the magnetic field unit 20, may be disposed within the air gap (AG).

The coil 50 may have a cylindrical shape so that a space in which the magnetic field unit 20 can move is formed, and the magnetic fluid 54 preventing the contact between the magnetic field unit 20 and the coil 50 may be provided in a clearance therebetween.

In the case of the linear vibrator 1 having the claw part 226 extended to a position corresponding to the center of mass (W) of the mass body 30, even if the mass body 30 is biased when an external impact is applied thereto, an edge portion of the yoke 20 moves toward an outer circumferential portion of the coil 50 due to the elasticity of the claw part 226 itself, such that the yoke 20 may not be moved by the applied impact (See FIG. 4).

A damper 55 may be formed in an upper surface of the bracket 14 and prevent the magnetic field unit 20 from contacting the housing 10 due to vibrations. The damper 55 may be made of a rubber material; however, a material of the damper 55 may be variously changed.

The magnetic field unit 20 may be connected to the housing 10 by an elastic member 40.

The elastic member 40 may include a housing fixing part 42 fixed to any portion of the upper case 12, a yoke fixing part 46 surface-contacting a surface opposite to a contact surface between the magnet 24 and the yoke 22, and a plurality of connecting strip parts 44 disposed such that an elastic space 45 is formed between the housing fixing part 42 and the yoke fixing part 46.

The housing fixing part 42 is a fixed end of the elastic member 40 fixed to the housing 10 that is not vibrated, and the yoke fixing part 46 is a free end of the elastic member 40 vibrated due to the vibration of the magnetic field unit 20.

The elastic member 40 may be a spring member, the yoke fixing part 46 may have a flat plate shape, the housing fixing part 42 may have an annular rim shape in which the center is open, and the connecting strip parts 44 may have a spiral shape connecting the yoke fixing part 46 and the housing fixing part 42.

Herein, the yoke fixing part 46 may be fixed to the flat part 222 of the yoke 22. The yoke fixing part 46 and the flat part 222 may have a bonding surface formed by the bonding therebetween.

An area of the annular bonding surface between the flat part 222 and the yoke fixing part 46 may be smaller than that of the yoke fixing part 46.

When the area of the yoke fixing part 46 is larger than that of the bonding surface, assembly tolerance for the bonding may be secured to improve assembling efficiency.

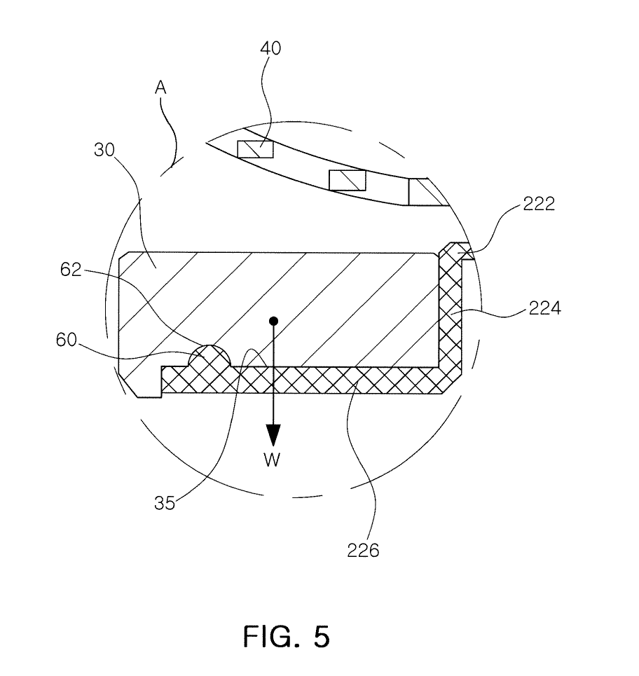

FIG. 5 is a partially enlarged cross-sectional view showing a modified example of part A of FIG. 2.

Referring to FIG. 5, one of the claw part 226 and the mass body 30 is provided with a fixing protrusion 60, and the other is provided with a fixing protrusion receiving part 62, wherein the fixing protrusion 60 is fixed to the fixing protrusion receiving part 62 to increase fixation between the claw part 226 and the mass body 30.

At this time, an insertion part 35 may be formed on the bottom of the mass body 30 to have the claw part 226 inserted thereinto, and an outer surface of an end of the claw part 226 may be coupled to an inner circumferential surface of the insertion part 35.

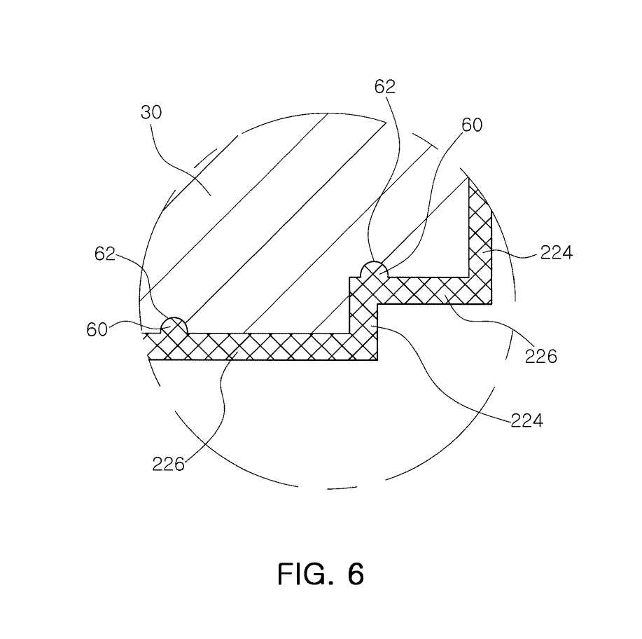

FIG. 6 is a partial cross-sectional view schematically showing a yoke supporting a mass body according to another exemplary embodiment of the present invention.

Referring to FIG. 6, it may be appreciated that the claw part 226 of the yoke 22 and the mass body 30 has a multistage structure unlike an exemplary embodiment of FIGS. 1 through 4.

In the case in which the claw part 226 of the yoke 22 and the mass body 33 have the multistage structure, the restoring force of the claw part 226 itself increases to thereby reduce the possibility that the claw part 226 will transfer the impact to the outer circumferential portion of the coil 50 due to the external impact.

Also, in the present structure, one of a stepped bottom of the mass body 30 and the claw part 226 surface-contacting the stepped bottom of the mass body 30 is provided with the fixing protrusion 60, and the other is provided with the fixing protrusion receiving part 62, wherein the fixing protrusion 60 may be fixed to the fixing protrusion receiving part 62 to thereby reduce a phenomenon that the mass body 30 is separated form the yoke 22 due to the external impacts and the like.

As set forth above, according to exemplary embodiments of the present invention, interference between a magnet and an inner diameter of a coil when external impacts are applied thereto may be avoided, whereby the disconnection of the coil may be prevented.

In addition, the generation of noise or damage due to the interference between the magnet and the inner diameter of the coil may be prevented.

While the present invention has been shown and described in connection with the exemplary embodiments, it will be apparent to those skilled in the art that modifications and variations can be made without departing from the spirit and scope of the invention as defined by the appended claims.

What is claimed is:

1. A linear vibrator comprising:
a housing having an internal space formed therein;
a magnetic field unit including a yoke disposed in the internal space and a magnet mounted on a surface of the yoke, and interacting with a coil to which power is applied to thereby generate vibrations in the internal space;
a mass body fixed to an outer surface of the yoke; and
a claw part being a portion of the yoke, supporting a bottom of the mass body, and extended to a position corresponding to the center of mass of the mass body.

2. The linear vibrator of claim 1, wherein the claw part is extended outwardly of a position corresponding to the center of mass of the mass body.

3. The linear vibrator of claim 1, wherein one of the claw part and the mass body is provided with a fixing protrusion and the other is provided with a fixing protrusion receiving part, and
the fixing protrusion is fixed to the fixing protrusion receiving part.

4. The linear vibrator of claim 1, wherein the bottom of the mass body is provided with an insertion part having the claw part inserted thereinto, and
an outer surface of an end of the claw part is coupled to an inner circumferential surface of the insertion part.

5. The linear vibrator of claim 1, wherein the claw part has a multi-stage structure and supports the bottom of the mass body in a multi-stage manner.

6. The linear vibrator of claim 5, wherein one of a stepped bottom of the mass body and the claw part surface-contacting the stepped bottom of the mass body is provided with a fixing protrusion and the other is provided with a fixing protrusion receiving part, and
the fixing protrusion is fixed to the fixing protrusion receiving part.

7. The linear vibrator of claim 1, wherein the housing includes a cylindrical upper case of which a lower portion is open and a bracket closing the lower portion of the upper case and having the coil mounted thereon.

8. The linear vibrator of claim 1, wherein the housing includes a damper formed on a surface thereof, the damper preventing the magnetic field unit from contacting the housing due to vibrations.

9. The linear vibrator of claim 1, wherein the magnetic field unit is connected to the housing by an elastic member,
the elastic member includes a yoke fixing part fixed to the yoke,
the yoke has a flat part having one surface bonded to the yoke fixing part and the other surface fixed to the magnet, and
an area of a bonding surface between the yoke fixing part and the flat part is smaller than that of the yoke fixing part.
